(19) United States
(12) Patent Application Publication
(10) Pub. No.: US 2008/0104163 A1
(43) Pub. Date: May 1, 2008

(54) Non-Uniform Sampling To Avoid Aliasing

(76) Inventor: Lee A. Barford, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/554,402

(22) Filed: Oct. 30, 2006

(51) Int. Cl. G06F 7/52

(52) U.S. Cl. 708/620

(57) ABSTRACT

A method for sampling includes selecting and sampling at uniform time steps over a collection time that is more than one period. Reordering the collected samples into “one period” and transforming the period from the time domain to the frequency domain.

### BACKGROUND

Nyquist frequency is defined as minimum required sampling frequency for a given signal frequency to avoid aliasing. It is based on (maximum) signal frequency that could be reliably measured with that minimum sampling frequency. Thus, the sampling frequency has to be larger than this Nyquist frequency. Sometimes half of this value is defined as the Nyquist frequency (to equal the above definition) so then the sampling frequency has to be larger than twice this Nyquist frequency. The Nyquist criterion relies on the sampling occurring at uniform time steps.

### SUMMARY

A method for sampling includes selecting and sampling at non-uniform time steps over a collection time that is more than one period. Reordering the collected samples into “one period” and transforming the period from the time domain to the frequency domain.

### BRIEF DESCRIPTION OF THE DRAWINGS

FIG. 1 is a process flow diagram according to the invention.

FIG. 2 illustrates a measurement apparatus using the method described in FIG. 1.

FIG. 3 is a process flow diagram corresponding to step 102 shown in FIG. 1.

### DETAILED DESCRIPTION

The Nyquist sampling limit arises when samples are taken at uniform intervals. If non-uniform intervals are used, the bandwidth of the frequency domain conversion is set at some higher level by some other limitation of the measurement system.

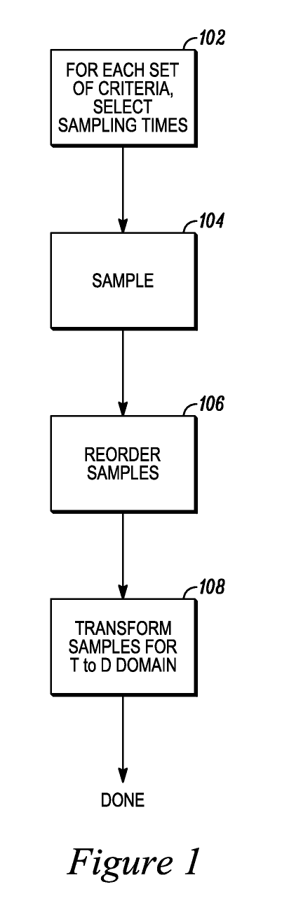

FIG. 1 illustrates a process flow diagram according to the invention. In step 102, for each set of criteria, sampling times are selected that are non-uniform while having a fast transformation into the frequency domain. In step 104, the sampling occurs. Step 104 may be repeated as often as required. In step 106, the samples are folded into “one period”. In step 108, the transformation from the time domain to the frequency domain occurs.

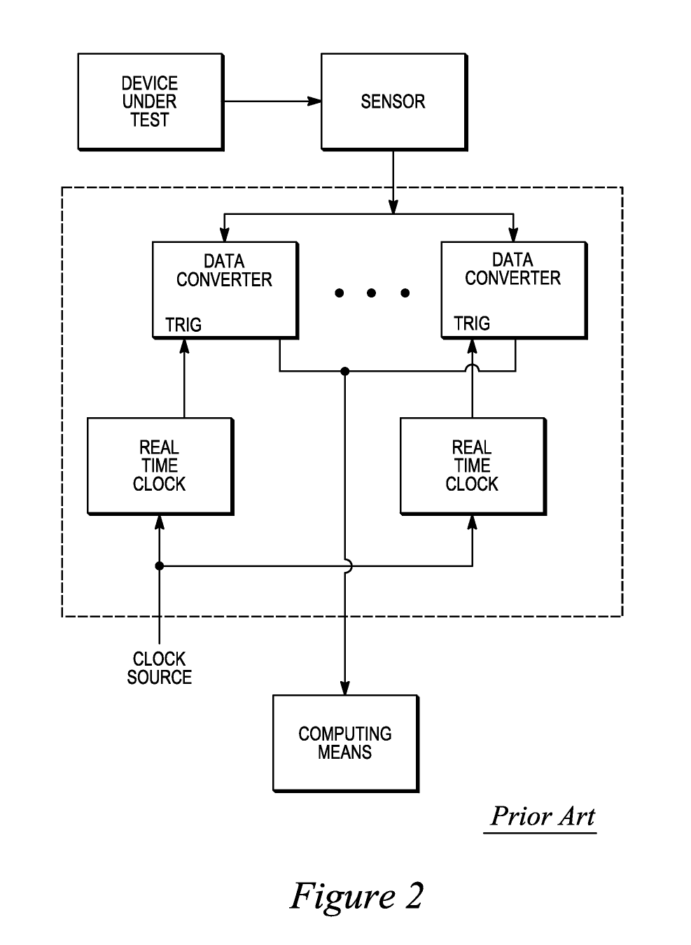

FIG. 2 illustrates a measurement apparatus. The physical variable of the system/device to be measured may be optionally sensed through a sensor. The sensor is not required if the data converters operate directly on the physical variable of interest, e.g. voltage. One or more data converters, e.g. ADCs, are configured to convert from the sensor output, if present, or to convert directly from the physical variable. Each data converter is configured so that it triggers when pre-programmed times are reached by an associated real-time clock. The digital data obtained by the data converters at those times are forwarded to a processor. The real-time clocks are synchronized with another using a time synchronization means, e.g. IEEE 1588, Network Time Protocol (NTP), or Global Positioning System (GPS). A suitable example is taught by Eidson in U.S. Pat. No. 6,741,952, assigned to Agilent Technologies, Inc.

### Notational Description

A matrix P is a permutation matrix containing all 0s except that each row contains one 1 and each column contains exactly one 1. Thus P=P[i, j, k . . . . ] means that the one in row 1 of P is in the i-th column, the one in row 2 of P is in the j-th column, etc. The identity matrix is noted as I=I[1, 2, 3, . . . ]
B(t,f) is the discrete Fourier basis matrix for frequency vector f and time vector t. It is equal to exp(2Π i ft^{T}), where i is the square root of −1.
t_{recover} is the minimum time that the time triggerable sampling means needs between taking consecutive samples.
t_{discr} is the discretization increment of the time trigger. Thus, the time triggers must be set to occur at times that are a multiple Of t_{discr}. Generally, t_{recover} is a multiple of t_{discr}.
diag is the function that takes a vector and returns a square matrix with dimension the same as that of the vector and has all zero elements except the elements of the vector form the main diagonal of the matrix.
floor is returns the greatest integer less than or equal to its argument.
ceil returns the least integer greater than or equal to its argument.

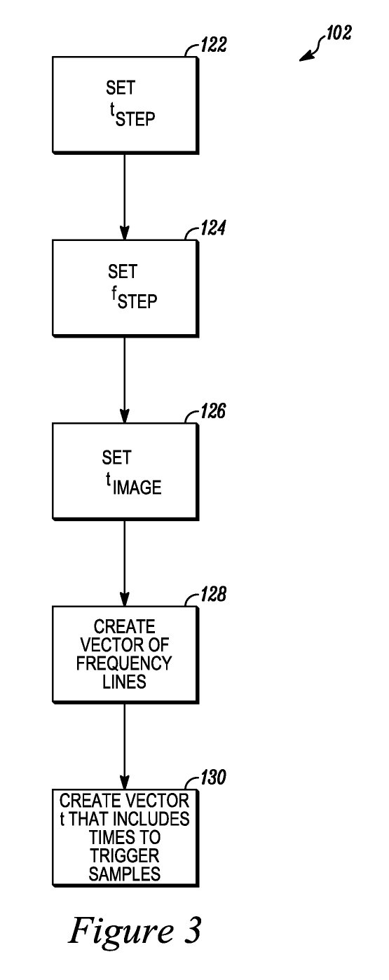

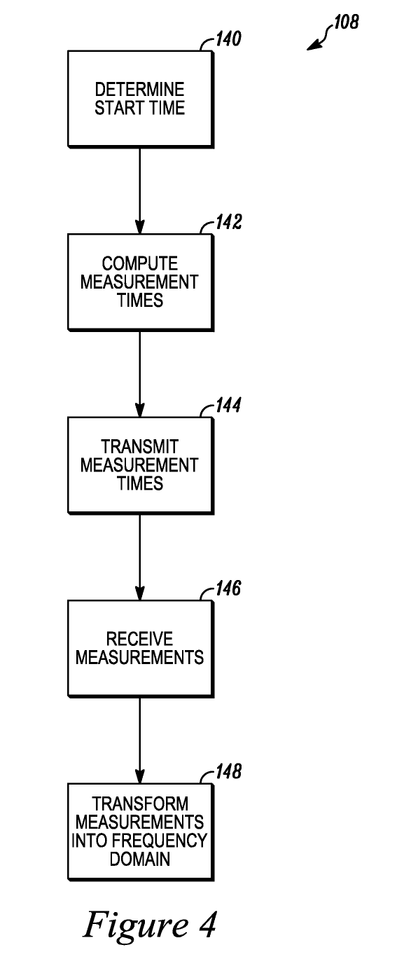

FIG. 3 is process flow diagram for step 102. The inputs are determined as follows. N is the number of frequencies (including both positive and negative frequencies) for which the vector spectrum is desired. For notational convenience, N is even. Let fₘₐₓ is the maximum frequency that is desired to appear in the spectrum. According to the Nyquist theorem, fₘₐₓ<1/t_{discr}/2 to avoid aliasing. In step 122, tₛₜₑₚ is set as the lower limit of (1/fₘₐₓ/2/t_{discr}) times t_{discr}. In step 124, fₛₜₑₚ is 1/tₛₜₑₚ/N. In step 126, t_{image} is set to tₛₜₑₚN. In step 128, the vector of frequency lines of spectrum f is set to be (−N/2·fₛₜₑₚ, (−N/2−1)·fₛₜₑₚ, . . . , (N/2−2)·fₛₜₑₚ, (N/2−1)·fₛₜₑₚ)^{T}. In step 128, the vector tvirt is (0, 1, . . . N−1)^{T}·tₛₜₑₚ. where vector tvirt is a vector of virtual sampling times equivalent to the sampling times actually used under the periodicity assumption In step 130, a new vector t of length N is created. In step 132, first t₁ is set to 0. Then for i=2, 3, . . . , N, tᵢ is set to tvirtᵢ₋₁+ceil((tᵢ₋₁+t_{recover})/t_{image})·t_{image}. Set P=I. At the conclusion of step 132, vector t contains the relative times at which to trigger the time-triggered sampling means.

There exists an infinite number of vectors t that may be used. t can be any vector for which there exists permutation matrix P that satisfies the following equation:

B(tvirt,f)=PB(t,f)

Examples of other vectors that meet the above requirement include all vectors t+c for any constant c. Applying Fourier analysis means that the signal is assumed to be periodic, hence another set of vectors t, each of which yields acceptable sampling times, includes all vectors P⁻¹(tvirt+(k₁/fₛₜₑₚ, k₂/fₛₜₑₚ, . . . k_{N}/fₛₜₑₚ)^{T}) for all choices of permutation matrix P and integers k₁, k₂, . . . k_{N}. In particular, P and k₁, k₂, . . . k_{N} may be chosen so as to reduce or minimize the total measurement time max(tvirt+(k₁/fₛₜₑₚ, k₂/fₛₜₑₚ, . . . k_{N}/fₛₜₑₚ)^{T}) such that any two sampling times must differ by at least t_{recover} by means for example of a greedy optimization algorithm.

FIG. 4 is a process flow diagram for step 108. The inputs are the permutation matrix P, vector tvirt, and vector t. w is a windowing function that maps the range [−1, 1] into the range [0,1]. Suitable windowing functions include the Hann and Hamming functions. The windowing function is used as the measured physical variable may not be periodic with period 1/fₛₜₑₚ as a Fourier transform assumes.

In step 140, compute the time to begin the measurements as the current real time plus the time T required to transmit the measurement request to the time-triggered sampling. In step 142, compute the times to perform the measurements, T+t. In step 144, transmit the request to perform the measurements at times T+t to the time-triggered sampling means. In step 146, wait until at least time T+t_{N}, next receive measurements (vector x, where xᵢ is the measurement taken at time T+tᵢ) into the computing means. In step 148, apply P and transform into the frequency domain.

I claim:

1. A method comprising:
selecting non-uniform sampling times according to a permutation matrix P;
sampling;
reordering the collected samples; and
transforming the period from the time domain to the frequency domain.

2. A method, as defined in claim 1, selecting comprising determining the number of non-uniform sampling times N, where N is an integer.

3. A method, as defined in claim 2, determining comprising:
setting a maximum frequency, fₘₐₓ;
setting one of the non-uniform sampling time to be the lower limit of (1/fₘₐₓ/2/t_{discr}) times t_{discr}, where t_{discr} is a discretization increment of a time trigger;
setting a step frequency, fₛₜₑₚ, to 1/tₛₜₑₚ/N;
setting a collection time to be a permutation matrix P⁻¹, where P⁻¹(tvirt+(k₁/fₛₜₑₚ, k₂/fₛₜₑₚ, . . . k_{N}/fₛₜₑₚ)^{T}), tvirt being a vector of virtual sampling times; and
setting a vector of frequency lines to be −N/2 times the step frequency fₛₜₑₚ.

4. A method, as defined in claim 2, determining comprising:
setting a maximum frequency, fₘₐₓ;
setting one of the non-uniform sampling times to be the lower limit of (1/fₘₐₓ/2/t_{discr}) times t_{discr}, where t_{discr} is a discretization increment of a time trigger;
setting a step frequency to 1/tstep/N;
setting a collection time to be a permutation matrix P⁻¹, where P=P⁻¹=I, k₁=0, and for i=2, 3, . . . , N, tᵢ=tvirtᵢ₋₁+ceil((tᵢ₋₁+t_{recover})/t_{image})·t_{image}, where t_{recover} is the minimum time between taking consecutive samples and tvirt is a vector of virtual sampling times; and
setting the vector of frequency lines to be −N/2 times the step frequency.

5. A method, as defined in claim 1, reordering comprising permuting the collected samples.

6. A system comprising:
a data converter, receiving an input signal, configured to trigger at set intervals, the set intervals being chosen to; and
a processor, connected to the data converter, including,
selecting non-uniform sampling times;
sampling;
reordering the collected samples; and
transforming the period from the time domain to the frequency domain.

7. A system, as defined in claim 6, further comprising a sensor generating the input signal.

8. A system, as defined in claim 6, reordering comprising permuting the collected samples.
